(19) United States
(12) Patent Application Publication
(10) Pub. No.: US 2011/0166285 A1
(43) Pub. Date: Jul. 7, 2011

(54) SEALING MASS THAT CAN BE CROSS-LINKED USING WATER

(76) Inventors: Lars Zander, Rommerskirchen (DE); Jens Lueckert, Mauer (DE); Martin Majolo, Erkelenz (DE); Andreas Bolte, Duesseldorf (DE); Johann Klein, Duesseldorf (DE); Thomas Bachon, Duesseldorf (DE); Sven Balk, Frankfurt (DE); Holger Kautz, Haltern am See (DE); Stephan Fengler, Frankfurt (DE)

(21) Appl. No.: 12/954,184

(22) Filed: Nov. 24, 2010

Related U.S. Application Data
(63) Continuation of application No. PCT/EP2009/055609, filed on May 8, 2009.

(30) Foreign Application Priority Data
May 28, 2008 (DE) 10 2008 025575.0

(51) Int. Cl. C08L 53/00

(52) U.S. Cl. 524/505

(57) ABSTRACT

The invention relates to a cross-linkable composition containing 10-50% by weight of silane-group terminated polymers with a number average molecular weight of between 3,000 and 30,000 g/mol, 0.5 to 20% by weight of (meth)acrylate block copolymers of type A(BA)ₙ, where n=1 to 5 and said copolymers contain at least two hydrolysable silane groups, 85 to 40% by weight of fillers and auxiliary agents, the sum of the constituents totalling 100%. The invention is characterised in that the (meth)acrylate block copolymers have a number average molecular weight of between 5,000 and 100,000 g/mol and that the silane groups are contained in at least one block A or B and said groups are not terminal in the polymer chain.

This application is a continuation of International Application No. PCT/EP2009/055609, filed May 8, 2009 and published on Dec. 17, 2009 as WO 2009/149999, which claims the benefit of German Patent Application No. 102008025575.0 filed May 28, 2008, the contents of each of which are incorporated herein by reference in their entirety.

The invention relates to compositions based on mixtures of silane terminated polyethers and block copolymers based on (meth)acrylate monomers, which comprise hydrolysable silane groups in at least one block.

Compositions based on silane-terminated polyethers are known. Such compositions can be employed as sealing compounds, adhesive compounds or in a similar way. EP-A 0673972 describes curable compounds that comprise an oxyalkylene polymer that comprises at least one reactive silicon group per molecule. Furthermore, the compounds comprise copolymers based on alkyl (methacrylates), wherein the copolymers are from alkyl acrylates with an alkyl group of up to 8 carbon atoms as well as alkyl acrylates with an alkyl group of more than 9 carbon atoms. The methacrylate copolymers optionally possess functional groups, such as epoxy groups, amino groups or also silane groups. No mention is made of a particular structure of the (meth)acrylate copolymers.

EP-A 0918062 is known. It describes a crosslinkable mixture of a silicone polymer that comprises hydrolysable silane groups, as well as a (meth)acrylate copolymer that likewise comprises hydrolysable silane groups. The known radically cleaving initiators are described as the initiators for manufacturing the acrylate copolymers. Block copolymers are not described and cannot be manufactured with the cited initiators. EP-A 1396513 is also known. It describes polyoxyalkylene polymers that comprise hydrolysable silane groups. These compositions can additionally comprise copolymers of polymerisable unsaturated monomers, for example styrene esters or acrylate esters. They can optionally also comprise hydrolysable silane groups that can be incorporated into the polymer by means of vinyl alkoxysilanes, for example. They concern normal statistical acrylate copolymers.

In addition, EP-A 1000980 is known. This patent describes curable compositions that comprise a polyether polymer or an epoxy resin with at least one crosslinkable silyl group as well as a vinyl polymer with at least one crosslinkable silyl group, wherein the polydispersity of this vinyl polymer is less than 1.8. The functionalized vinyl polymers are obtained by treating vinyl polymers that still comprise unsaturated double bonds with silane derivatives that react with the double bond. Another described method is the nucleophilic substitution of polymerized carbon-halogen bonds by compounds that possess nucleophilic groups as well as crosslinkable silane groups. In particular, the described embodiments have a silane group on the chain ends.

EP-A 1036807 is also known. Here, polyoxyalkylene polymers are described that are at least 85% substituted on the chain ends with silane groups. Here, for the described diols there are therefore at most 2 or less than 2 silane groups present in the chain. A combination of such polymers with specific acrylate copolymers is not described.

Acrylate copolymers that possess only one reactive silane group can only be incorporated into a polymer matrix as a side chain. In particular, when the silane group is terminal, the acrylate chains act as an internal plasticizer. If the reactive silane groups are polymerized into the chain then this generally occurs in a statistical manner such that different polymer forms are obtained. Consequently a targeted structural design of a crosslinkable polymer can only be achieved with difficulty. Moreover, polymers of this type have the disadvantage that due to the low content of crosslinking groups, a strong and elastic polymer network cannot be formed. In addition, due to the low number of silane groups in the polymer, adhesion to various substrates can be realized only with difficulty. Acrylate copolymers that are produced by conventional radical polymerization exhibit a high dispersity (measured as M_{W}: M_{N}). This means that the viscosity behavior is poor and the viscosity is very high.

Due to the various disadvantages of the known crosslinkable compositions, the object is to provide a crosslinkable 1-component polymer mixture that comprises polyoxyalkylene polymers as the ingredients, which crosslink through silane groups and which possess an adequate number of silane groups in order to form an elastic network, and in addition to enable an adequate adhesion to the various substrates. Furthermore, (meth)acrylate block copolymers which likewise possess silane groups should be comprised as an ingredient. In this way a chosen structure of these copolymers can be obtained which form microstructures in the crosslinked composition, thereby affording crosslinked polymer compounds with an excellent mechanical strength. Likewise, due to the distribution of the reactive silane groups, a high elasticity can be obtained on crosslinking.

The object is achieved by a curable composition comprising 10 to 50 wt. % of silane group terminated polymers with a number average molecular weight of 3000 to 30 000 g/mol, 0.5 to 20 wt. % of (meth)acrylate block copolymers of the A(BA)ₙ type, with n from 1 to 5, which comprise at least two hydrolysable silane groups, 85 to 40 wt. % of fillers and auxiliaries, wherein the sum of the ingredients is intended to be 100%, wherein the (meth)acrylate block copolymers have a number average molecular weight of 5000 to 100 000 g/mol, the silane groups are comprised in at least one block A or B, wherein the silane groups are not terminal in the polymer chain.

Polymers that comprise hydrolysable functional groups that can crosslink with the functional groups of the block copolymer are an essential element of the crosslinkable composition. Here, they concern silane groups that carry 1 to 3 hydrolysable groups on the silane moiety. In this case, up to 10 silane groups can be present on the polymer chain, although it is preferred that 2 or 3 reactive silane groups are comprised.

A suitable component of the composition according to the invention, are polymers of the formula,

P—(R¹—R²—Si R_{q}³—(OR⁴)ₙ)ₘ (I)

in which P is an organic backbone,
R¹ means an amide, carboxyl, carbamate, carbonate, ureido, urethane or sulfonate bond, an oxygen atom, a sulfur atom or a methylene group,
R² is a straight chain or branched, substituted or unsubstituted alkylene group containing 1 to 8 carbon atoms,
R³ is an alkyl group containing 1 to 4 carbon atoms or OR⁴,
R⁴ is an alkyl group containing 1 to 4 carbon atoms or an acyl group containing 1 to 4 carbon atoms,
q=0, 1, 2,
n=3−q and
m=1 to 10, preferably 1 to 3,
wherein the groups R³ or R⁴ can be the same or different.

The organic backbone P is preferably selected from the group comprising polyamides, polyesters, polycarbonates, polyethylenes, polybutylenes, polystyrenes, polypropylenes, polyoxymethylene homopolymers and copolymers, polyurethanes, vinyl butyrates, vinyl polymers, ethylene copolymers, ethylene acrylate copolymers, organic rubbers and the like, or mixtures of different silylated polymers, wherein the backbone can also comprise siloxane groups in the main chain. For example, polyethers based on ethylene oxide, propylene oxide and tetrahydrofuran are also suitable. Polyethers and polyurethanes are preferred among the cited polymeric backbones. Polypropylene glycol is particularly preferred.

Suitable isocyanate-terminated PU prepolymers for the composition according to the invention are known to the person skilled in the art. Room temperature-curable siloxane-terminated organic sealing compositions have already been disclosed in U.S. Pat. No. 4,222,925 and U.S. Pat. No. 4,345,053, wherein in particular, isocyanate-free silane-terminated polyurethane prepolymers are described. They can be manufactured from the products of reaction of isocyanate-terminated polyurethane prepolymers with 3-aminopropyl trimethoxysilane or 2-aminoethyl-, 3-aminopropyl methoxysilane. Such PU prepolymers can be manufactured by reacting diols with a stoichiometric excess of polyisocyanate. Here, the known paint or adhesive isocyanates, generally diisocyanates, can be employed.

For example, EP-A 0 931 800 describes the manufacture of suitable silylated polyurethanes by reacting a polyol component, containing a terminal unsaturation of less than 0.02 meq/g, with a diisocyanate to form a hydroxyl-terminated prepolymer that is subsequently treated with an isocyanato silane of the formula OCN—R—Si—(X)ₘ(—OR¹)₃₋ₘ, wherein m is 0, 1 or 2 and each R¹ group is an alkyl group containing 1 to 4 carbon atoms and R is a difunctional organic group. According to the teaching of this document, these kinds of silylated polyurethanes exhibit a superior combination of mechanical properties, and cure in reasonable spaces of time to a slightly tacky sealant, without exhibiting an excessive viscosity.

Other suitably functionalized PU prepolymers are disclosed in WO-A-2003 066701. Here, polyurethane prepolymers having alkoxysilane and OH end groups based on high molecular weight polyurethane prepolymers with low functionality are used as binders for low-modulus sealants and adhesives. For this, a polyurethane prepolymer of a diisocyanate component having an NCO content of 20 to 60% and a polyol component, containing a polyoxyalkylene diol with a molecular weight between 3000 and 20 000 g/mol as the major component, should be initially reacted, wherein the reaction should be stopped when 50 to 90% of the OH groups have been converted. This reaction product should then be further reacted with a compound that possesses alkoxysilane and amino groups. These measures enable prepolymers with relatively medium molecular weights and low viscosity to be obtained, thereby permitting a high level of properties to be achieved.

The following itemized processes have already been described for manufacturing silane-terminated prepolymers based on polyethers:

Copolymerization of unsaturated monomers with those that contain alkoxysilyl groups, such as e.g. vinyl trimethoxysilane. Grafting unsaturated monomers such as vinyl trimethoxysilane onto thermoplastics such as polyethylene.

In an ether synthesis, hydroxy-functional polyethers are treated with unsaturated chlorine compounds, e.g. allyl chloride, to afford polyethers having terminal olefinic double bonds that are themselves treated with hydrosilane compounds that have hydrolysable groups, such as e.g. HSi(OCH₃)₃, in a hydrosilation reaction catalyzed for example by transition metal compounds of Group 8, to afford silane-terminated polyethers.

In another process, the polyethers that contain olefinically unsaturated groups are treated with a mercapto silane such as e.g. 3-mercaptopropyl trialkoxysilane.

In yet another process, hydroxyl group-containing polyethers are initially treated with di- or polyisocyanates, which are then themselves treated with amino-functional silanes or mercapto-functional silanes to afford silane-terminated prepolymers.

Another possibility envisages the treatment of hydroxy-functional polyethers with isocyanato-functional silanes such as e.g. 3-isocyanatopropyl trimethoxysilane.

In a preferred embodiment of the invention, such polyurethanes or especially polyethers have a number average molecular weight (M_{N}, as can be determined by GPC) of about 5000 to about 30 000 g/mol, especially about 6000 to about 25 000 g/mol. Polyethers with number average molecular weights of about 10 000 to about 22 000 g/mol, especially with molecular weights of about 12 000 to about 18 000 g/mol are particularly preferred. Depending on the method of manufacture, the polydispersity D of the preferred employed polyoxyalkylene polymers is maximum 1.7 or from ca. 2 to 4. The polydispersity of particularly preferred suitable polyether polymers is about 1.01 to about 1.3 or greater than 2.4.

Such polymers are commercially available under various trade names. The person skilled in the art can select them according to his ideas on desired reactivity or desired molecular weight.

The inventive composition must additionally possess (meth)acrylate block copolymers that comprise at least two hydrolysable silane groups. These block copolymers should have the structure A(BA)ₙ, wherein n should be 1 to 5. The characteristics of block copolymers of this type are significantly different from those of the known statistical acrylate copolymers. Suitable (meth)acrylate copolymers and processes for their manufacture are described for example in the still unpublished DE 10 2007 039 535. Furthermore, suitable functionalized (meth)acrylate polymers are described in the patent application DE 10 2008 002 016 that was filed at the same time by the patent applicant.

The notation (meth)acrylate stands for the esters of (meth)acrylic acid and here means both methacrylate esters and acrylate esters. Monomers that can be polymerized both in block A as well as in block B are selected from the group of the (meth)acrylates, such as for example alkyl (meth)acrylates of straight chain, branched, cycloaliphatic or aromatic substituted alcohols containing 1 to 40 carbon atoms or with mono or di-alcohols based on polyalkylene oxides. Monomers of this type and the glass transition temperatures of the resulting copolymers are known to the person skilled in the art.

Besides the (meth)acrylates, the compositions to be polymerized can also contain additional unsaturated monomers that are copolymerizable by ATRP. They include for example 1-alkenes, branched alkenes, vinyl esters, derivatives of maleic acid, optionally substituted styrenes and/or heterocyclic compounds. Monomers that are polymerisable by ATRP and which are not part of the group of the (meth)acrylates can be added in amounts of 0-50 wt. % both to the monomers of block A as well as to the monomers of block B, or even in both block types.

The block copolymers are manufactured by a sequential polymerization process. For this the monomer mixture for synthesizing a block, for example A, is only added to the reaction mixture when the monomer mixture for synthesizing the preceding block, for example B, has undergone at least 90% conversion, preferably at least 95% conversion. This process ensures that the blocks A or B comprise preferably less than 5% of the total amount of monomers of the other composition. The boundaries are located at the respective position in the chain, on which the first repeat unit of the newly added monomer mixture is located. In this way individual blocks can also be realized as a gradient polymer in the composition.

Both of the block types A and B differ in their composition of the monomer mixture. In a preferred embodiment, the monomers of A and B are selected, such that the blocks, as individual polymers, exhibit a different T_{g} (glass transition temperature, determined with DSC). That means that the difference of the T_{g} should be more than 5° C., especially more than 10° C. In one embodiment, block A for example can have a T_{g} greater than 0° C., block B less than 0° C. In another embodiment, both blocks can exhibit a T_{g} below 0° C.

The inventively suitable block copolymers should comprise at least two hydrolysable silane groups, wherein the silane groups should be present either in blocks of the type A or of the type B. It is also optionally possible for the silane groups to be comprised in two or more similar blocks. The silane groups should not be present in the terminal positions of the polymer chain. This can be ensured by the production process. It is also possible for the silane groups to be statistically distributed over a polymer block, another embodiment has the silane groups in proximity to the transition point between the blocks A and B, another embodiment comprises them in proximity to, but not at the free end of the chain. It is preferred when especially two blocks comprise hydrolysable silane groups. The incorporation of the silane monomers can be controlled by the timing of the addition to the polymerization.

The silyl group-containing copolymerized monomers that provide functionality are characterized by the following general formula:

H₂C═CR⁷C(O)O—R⁸—Si(OR⁵)_{b}R⁶ₐX_{c} (II)

In this regard the organic groups R⁵ and R⁶ can be identical or different from one another. Moreover, the organic groups R⁵ and R⁶ are selected from the group of the aliphatic hydrocarbon groups consisting of 1 to 20 carbon atoms. These groups can be either linear, branched or cyclic. R⁵ can be also exclusively hydrogen. H, CH₃ or C₂H₅ are preferred. X is selected from the group of the hydrolysable groups that are neither alkoxy nor hydroxy. It includes inter alia halide, acyloxy, amino, amido, mercapto, alkenyloxy and similar hydrolysable groups. a, b and c are each whole numbers between 0 and 3, wherein the sum of a+b+c is 3. R⁷ concerns a hydrogen or an aliphatic hydrocarbon group consisting of 1 to 20 carbon atoms. R⁷ is preferably hydrogen (acrylates) or a methyl group (methacrylates). The group R⁸ is a divalent group. R⁸ is preferably a divalent aliphatic hydrocarbon group consisting of 1 to 20 carbon atoms. R⁸ is particularly —CH₂—, —(CH₂)₂— or —(CH₂)₃.

A commercially available monomer is for example Dynasilan® MEMO from Evonik-Degussa. This is a 3-methacryloxypropyl trimethoxysilane.

The polymerization can be carried out in any halogen-free solvent, as well as in low viscosity plasticizers. In particular the ATRP process is used. It can also be carried out as an emulsion, mini-emulsion, micro-emulsion, suspension or substance polymerization.

The block copolymers are synthesized by sequential polymerization. Polymerization process technology is known to the person skilled in the art.

Bifunctional initiators based on halogenated esters, ketones, aldehydes or aromatic compounds are employed. These are known to the person skilled in the art. Catalysts for ATRP are itemized for example in Chem. Rev. 2001, 101, 2921. Copper complexes are predominantly described—however, iron, rhodium, platinum, ruthenium or nickel compounds are also used. An alternative to the described ATRP is a variant thereof: In the so-called reverse ATRP, compounds in higher oxidation states can be employed.

After a successful ATRP the transition metal compound can be precipitated out by the addition of a suitable sulfur compound. The sulfur compounds are preferably compounds containing an S—H group. One of the known free radical polymerization moderators, such as ethylhexyl mercaptan or n-dodecyl mercaptan, are quite particularly preferred. Silyl mercaptans, such as for example 3-mercaptopropyl trimethoxysilane, can also be used for increasing the degree of silyl functionality.

Such block copolymers should exhibit a structure ABA or BAB or higher homologs containing at least 1 and at most 10 silyl groups in each of the individual A-blocks. In this case, block A should represent a copolymer moiety, comprising silyl-functionalized (meth)acrylates and monomers selected from the group of the (meth)acrylates, and block B should be a copolymer, comprising one or more (meth)acrylates that do not carry any additional silyl-function, and be polymerized as ABA-block copolymers. ABA- or BAB-block copolymers containing at least 1 and at most 2 silyl groups in the individual A-blocks can also be synthesized.

In a preferred embodiment, block copolymers have at least 2 and at most 4 silyl groups in the individual A-blocks in an ABA structure. Another embodiment of the invention provides block copolymers that are functionalized in a controlled manner only in the end segments of the polymer chain. For example, another embodiment of the ABABA structure possesses a silane functionalization only in the externally positioned A-blocks.

Alternatively, it is also possible for the block A not to be functionalized, rather the block B is functionalized with the silane monomers.

The block copolymers of the composition ABA are constituted by A-blocks to less than 25% of the total weight, preferably to less than 10%.

The inventively employable block copolymers should have a number average molecular weight between 5000 and 100 000 g/mol, especially between 7500 and 50 000 g/mol, preferably up to 35 000 g/mol. The polydispersity can be influenced. It can be 1.6, preferably below 1.4; however, in order to obtain specific properties, it is also possible to adjust these values to a value greater than 1.8, especially greater than 2. The polymers according to the invention can be obtained as solvent-free polymers; however, it is also possible for them to be in solution with organic solvents or plasticizers.

The composition according to the invention can comprise, in addition to both silane group-containing polymers, various additives, such as polymers, oligomers or low molecular weight ingredients in reactive or inert form, stabilizers, catalysts, pigments and fillers or other additives.

Reactive diluents can be comprised, for example. As reactive diluents, all compounds can be added that are miscible with the adhesive or sealant and reduce the viscosity and that carry at least one group that is reactive with the binder. The reactive diluent preferably possesses at least one functional group that after the application reacts for example with moisture or atmospheric oxygen. Examples of such groups are silyl groups, isocyanate groups, vinylic unsaturated groups and polyunsaturated systems. The viscosity of the reactive diluent is preferably less than 20 000 mPas, particularly preferably about 1 to 6000 mPas, quite particularly preferably 10 to 1000 mPas (Brookfield RVT, 23° C., spindle 7, 10 rpm, measured according to EN ISO 2555).

Low molecular weight substances, for example can be added as the reactive diluent, such as polyalkylene glycols reacted with isocyanato silanes, alkyl trimethoxysilane, alkyl triethoxysilane, vinyl trimethoxysilane, vinyl triethoxysilane, phenyl trimethoxysilane, phenyl triethoxysilane, octyl trimethoxysilane, tetraethoxysilane, vinyl dimethoxymethylsilane, vinyl triethoxysilane, vinyl triacetoxysilane, isooctyl trimethoxysilane, isooctyl triethoxysilane, N-dimethoxy(methyl)silylmethyl-O-methyl-carbamate, hexadecyl trimethoxysilane, 3-octanoylthio-1-propyl triethoxysilane and their partially hydrolyzed compounds.

Polymers that can be produced by grafting a vinyl silane onto an organic backbone or by reacting polyol, polyisocyanate and alkoxysilane can also be added as the reactive diluent.

In the scope of the present invention, the compound present as the reactive diluent preferably possesses at least one alkoxysilyl group, especially di- and trialkoxysilyl groups. Inventively preferred reactive diluents are manufactured by treating a suitable polyol component with an at least difunctional isocyanate. The di- and polyisocyanates known in the paint and adhesive chemistry or oligomers, such as tri-isocyanurates or biurets or uretdiones of in particular aliphatic diisocyanates, can be considered for use as the at least difunctional isocyanate. An excess of the isocyanates is reacted, thereby forming NCO-terminated prepolymers. Suitable reactive diluents can be produced from the isocyanate-reactive prepolymers by reaction with reactive silanes.

The viscosity of the inventive composition can also be reduced by adding solvent/plasticizer in addition to, or instead of, a reactive diluent.

The known paint solvents can be added as the solvent. However, alcohols, for example C₁-C₁₀ alcohols, are preferably added as in this case the shelf life increases.

The composition according to the invention can further comprise hydrophilic plasticizers. Exemplary suitable plasticizers are esters of aliphatic or aromatic carboxylic acids with linear or branched alcohols containing 1 to 12 carbon atoms, such as abietic acid esters, adipic acid esters, azelaic acid esters, benzoic acid esters, fatty acid esters, glycolic acid esters, phosphoric acid esters, phthalic acid esters, propionic acid esters, sebacic acid esters, sulfonic acid esters, trimellitic acid esters, or citric acid esters.

Exemplary suitable catalysts for controlling the cure rate of the inventive curable compositions are organometallic compounds, iron or tin compounds, such as tin-(II)-carboxylates, dialkyltin-(IV)-dicarboxylates, iron acetyacetonate; titanium, aluminum and zirconium compounds, such as alkyl titanates, organosilicon titanium compounds, titanium chelate complexes, aluminum chelate complexes, aluminum alkoxides, zirconium chelate complexes, zirconium alkoxides; bismuth carboxylates; acidic compounds, such as phosphoric acid, p-toluene sulfonic acid, boron halides, optionally as liquid complexes, aliphatic amines, diamines or polyamines. Mixtures of one or more catalysts from one or more of the abovementioned groups can also be employed. Boron trifluoride complexes, iron and titanium carboxylates or tin carboxylates are particularly preferred. The catalyst, preferably a mixture of a plurality of catalysts, is added in an amount of 0.01 to about 5 wt. %, especially up to 3 wt. %, based on the total weight of the composition.

Moreover, the composition according to the invention can comprise up to about 20 wt. % of customary tackifiers. Exemplary suitable tackifiers are resins, terpene oligomers, coumarone/indene resins, aliphatic, petrochemical resins and modified phenolic resins. Copolymers of terpenes and other monomers, for example styrene, α-methyl styrene, isoprene and the like, are also counted among the terpene resins. The terpene-phenol resins, which are manufactured by acid catalyzed addition of phenols to terpenes or colophonium are also suitable. Terpene-phenol resins are soluble in most organic solvents and oils and are miscible with other resins, waxes and rubber. In the context of the present invention, the colophonium resins and their derivatives, for example their esters or alcohols, are likewise suitable in the above sense as additives.

Furthermore, the composition according to the invention can additionally comprise up to about 5 wt. % of additional additives such as antioxidants or stabilizers. In particular, the known hindered amine light stabilizers (HALS) can be added. UV-stabilizers that carry a silyl group that during the crosslinking or curing is built into the final product, can also be added.

It often makes sense to add drying agents in order to further stabilize the inventive compositions against the ingress of moisture so as to further increase the shelf life. Isocyanates or silanes are suitable, for example. The abovementioned reactive additives, based on isocyanates or hydrolysable silanes can also be used. Examples are isocyanato silanes, vinyl silanes, oxime silanes or tetraalkoxysilanes. The amount of drying agent can be up to about 6 wt. %.

The composition according to the invention can additionally comprise fillers. Exemplary suitable fillers are chalk, lime powder, precipitated and/or pyrogenic silicas, zeolites, bentonites, magnesium carbonate, diatomaceous earth, alumina, clay, talc, titanium oxide, iron oxide, sand, quartz, flint, mica, glass powder and other ground mineral substances. Moreover, organic fillers can also be added, especially carbon black, graphite, wood fibers, wood flour, sawdust, cellulose, cotton, pulp, cotton, hogged chips, chopped straw, chaff, ground walnut shells and other chopped fibers. Furthermore, short fibers such as glass fiber, glass filament, polyacrylonitrile, carbon fiber, Kevlar fiber or also polyethylene fibers can also be added. Aluminum powder is also a suitable filler.

Hollow spheres with a mineral sheath or a plastic sheath are also suitable fillers. They can be hollow glass spheres for example or hollow spheres based on plastic. In this case the diameter should be less than 0.5 mm, preferably 300 μm.

The compositions according to the invention should comprise 10 to 50 wt. % silane group-terminated polyether, 0.5-20 wt. % (meth)acrylate block copolymers that comprise at least two hydrolysable silane groups, as well as 85-40 wt. % fillers and auxiliaries, wherein the sum of the ingredients should be 100%. In particular, the content of the (meth)acrylate block copolymers should be 1 to 10 wt. %. The content, based on the content of the silyl group-terminated polyether, should be less than 33%. In a preferred embodiment, both polymers have a low dispersity, especially less than 1.7; in another embodiment D of the block copolymers should be 2.0 to 2.4. This makes it possible to keep the viscosity of the composition low.

The crosslinkable compositions according to the invention can be employed as sealing compounds, adhesives or as surface coatings. The compositions can be applied by known techniques; in general a pre-treatment of the substrate is not necessary. The compositions according to the invention can crosslink in the presence of moisture from the surroundings. This causes the polymeric ingredients that can react together through the silane groups to form a common network. The resulting crosslinked compounds are elastic. The exhibit a good adhesion to the various substrates.

In particular, if the substrates exhibit a certain surface moisture, then a rapid and good adhesion to the surface is observed.

The crosslinked compounds are weather resistant. Usually they decompose only slightly under the influence of light. By the same token, stable compounds are also obtained under the influence of moisture even under increased ambient temperature.

The adhesion to the different substrates is improved by the inventive addition of the silane-reactive (meth)acrylate block copolymers. Moreover, due to the structures of the block copolymers, a particularly advantageous elastic behavior of the crosslinked compounds is observed.

The invention is illustrated by means of the following examples.

### Example Acrylate Block Copolymer 1, 2:

In a double jacketed vessel equipped with stirrer, thermometer, reflux cooler, nitrogen supply tube and dropping funnel were placed under a N₂ atmosphere, monomer lb (exact name and quantities in Table 2), 150 ml propyl acetate, 0.60 g copper(I) oxide and 1.6 g N,N,N′,N″,N′″-pentamethyldiethylenetriamine (PMDETA). The solution was stirred at 80° C. for 15 minutes. At the same temperature, the initiator 1,4-butane diol di-(2-bromo-2-methylpropionate) (BDBIB, quantity see Table 1), dissolved in 35 ml propyl acetate, was then added dropwise. After the polymerization time of 3 hours, a sample was removed for the determination (by SEC) of the average molecular weight Mₙ and a mixture of monomer IIb and monomer IIIb (exact name and quantities in Table 2) were added. After a calculated 95% conversion, monomer IIb′ was finally added (exact name and quantities in Table 2). The mixture was polymerized to an expected conversion of at least 95% and interrupted by the addition of 2.4 g n-dodecyl mercaptan. The solution was worked up by filtration over silica and the volatile components were subsequently removed by distillation. The average molecular weight and the molecular weight distributions M_{w}/Mₙ were determined by gel permeation chromatography (GPC) in tetrahydrofuran against a PMMA standard. The fraction of copolymerized monomer 3a was quantified by ¹H-NMR measurements.

Number average and weight average molecular weights Mₙ and M_{w} as per Table 2.

TABLE 2

| Example | 1 | 2 |
|---|---|---|
| Monomer I | Ia) n-BA | Ib) n-BA |
| Quantity | 95.2 g | 96.5 g |
| Monomer II | IIa) MMA | IIb) MMA |
| Quantity | 19.8 g | 4.2 g |
| Monomer II′ | IIa′) MMA | IIb′) MMA |
| Quantity | 4.0 | 19.8 |
| Monomer III | IIIa) MEMO | IIIb) MEMO |
| Quantity | 5.9 | 5.0 |
| Initiator quantity | 1.70 g | 1.62 g |
| Mn (1st step) | 17800 | 26700 |
| D | 1.22 | 1.31 |
| Mn (2nd step) | 21600 | 30500 |
| D | 1.23 | 1.47 |
| Mn (3rd step)1 | 23400 | 32000 |
| D | 1.36 | 1.63 |

MMA = methyl methacrylate;
n-BA = n-butyl acrylate,
MEMO = Dynasylan MEMO (3-methacryloxypropyl trimethoxysilane);
1 GPC measurements of the third step prior to adding mercaptan

Example Polyether Silane 3:

282 g (15 mmol) polypropylene glycol 18000 (OH number=6.0) were dried in a 500 ml three-necked flask at 100° C. under vacuum. Under a nitrogen atmosphere at 80° C. were added 0.1 g DBTL and then 7.2 g (32 mmol) isocyanatopropyl trimethoxysilane. After stirring for one hour at 80° C. the resulting polymer was cooled and treated with 6 g vinyl trimethoxysilane.

Example Sealing Compound 4:

| | |
|---|---|
| Silane-functionalized polyether (B3) | 25% |
| Polyacrylate (B1) | 3% |
| Diisoundecyl phthalate | 17.5% |
| Chalk U1S2 (coated) | 49.5% |
| Vinyl trimethoxysilane (drying agent) | 1.4% |
| Titanium dioxide | 2.5% |
| Aminopropyl trimethoxysilane (adhesion promoter) | 0.9% |
| DBTL | 0.1% |
| Stabilizer (Tinuvin) | 0.1% |

Example Sealing Compound 5:

| | |
|---|---|
| Silane-functionalized polyether (BB3) | 22% |
| Polyacrylate (B2) | 6% |
| Diisoundecyl phthalate | 17.5% |
| Chalk U1S2 (coated) | 49.5% |
| Vinyl trimethoxysilane (drying agent) | 1.4% |
| Titanium dioxide | 2.5% |
| Aminopropyl trimethoxysilane (adhesion promoter) | 0.9% |
| DBTL | 0.1% |
| Stabilizer (Tinuvin) | 0.1% |

The polymers were mixed in a high speed mixer and then the pigments were added. The additives, such as catalyst, adhesion promoter, drying agent, were then added and homogenized. The compound according to the invention is pasty at room temperature and is storable in the absence of water.

After curing, the specimens on beech wood specimens showed a shear strength of >3 N/mm².

The adhesion to wood, PVC, polycarbonate or ABS specimens is good.

1. A crosslinkable composition comprising:
10-50 wt. % of silane group terminated polymers with a number average molecular weight of between 3000 and 30 000 g/mol,
0.5-20 wt. % of (meth)acrylate block copolymers of the A(BA)ₙ type, with n=1 to 5, which comprise at least two hydrolysable silane groups, and
85-40 wt. % of fillers and auxiliaries,
wherein the sum of the ingredients is intended to be 100%, and wherein the (meth)acrylate block copolymers have a number average molecular weight of 5000 to 100 000 g/mol, the silane groups are comprised in at least one block A or B, wherein the silane groups are not terminal in the polymer chain.

2. The crosslinkable composition according to claim 1 wherein the silane group terminated polymers are selected from polyethers and/or polyurethanes.

3. The crosslinkable composition according to claim 1 wherein 1 to 10 silane groups are contained per functionalized block.

4. The crosslinkable composition according to claim 1 wherein 2 to 4 silane groups are contained per functionalized block.

5. The crosslinkable composition according to claim 1 wherein n is one or two.

6. The crosslinkable composition according to claim 1 wherein the silane groups are comprised in both A-end blocks.

7. The crosslinkable composition according to claim 1 wherein the silane groups are comprised in at least one B-block.

8. The crosslinkable composition according to claim 1 wherein the silane groups are statistically distributed over each functionalized block or are located as a gradient at the beginning or end of a block.

9. The crosslinkable composition according to claim 1 wherein the blocks A and B as a copolymer exhibit a difference in the T_{g} of 5° C.

10. The crosslinkable composition according to claim 1 comprising 1 to 10 wt. % of (meth)acrylate block copolymers and the amount of the acrylate polymer is less than 33 wt. %, based on the fraction of the silane group terminated polyether.

11. The crosslinkable composition according to claim 1 wherein the dispersity of the silane group terminated polyether is less than 1.7 or more than 2.4.

12. The crosslinkable composition according to claim 1 wherein the fillers and auxiliaries are selected from reactive diluents, pigments, fillers, stabilizers, plasticizers, adhesion promoters, catalysts and/or crosslinkers.

13. The crosslinkable composition according to claim 1 comprising 0.01 to 5 wt. % of a catalyst.

14. A solvent-free sealant, adhesive or coating agent comprising the composition according to claim 1.

15. A sealing compound in the construction industry comprising the composition according to claim 1.
